(19) United States
(12) Patent Application Publication
(10) Pub. No.: US 2009/0112680 A1
(43) Pub. Date: Apr. 30, 2009

(54) System for interaction with celebrities

(76) Inventors: Ido Dovrath, Tel Aviv (IL); Assaf Dovrath, Tel Aviv (IL); Nurit Dovrath, Tel Aviv (IL)

Correspondence Address: ROBERT G. LEV, 4766 MICHIGAN BLVD., YOUNGSTOWN, OH, 44505, US

(21) Appl. No.: 11/977,570

(22) Filed: Oct. 25, 2007

(51) Int. Cl. G06F 17/30; G06Q 30/00

(52) U.S. Cl. 705/9; 705/14; 705/26

(57) ABSTRACT

A method for commercializing a celebrity's time, comprising the steps of: defining a session for interaction with celebrity; offering the session for sale via a medium, such as the Internet; accepting an offer from a buyer and scheduling the session with the buyer such that said celebrity is obligated to interact with the user during the session

### FIELD OF THE INVENTION

The present invention concerns the relationship between a celebrity and his/her audience. In particular, the present invention concerns augmenting the relationship between celebrities and their audience or fan club, by providing the celebrity and audience members with an opportunity to interact with each other in a time-efficient and cost-efficient manner by offering the audience members individual interactive sessions with the celebrity.

### BACKGROUND

Celebrities interact indirectly with their audiences via the media, such as when an interview with a celebrity is published in a magazine or broadcast on TV. Such indirect interactions are unidirectional in that the celebrity is exposed to the audience but the celebrity is unaware of the individual audience members. The individual members of the audience are only too aware that the celebrity is unaware of them and that the exposure is one sided.

Celebrities are exposed to their audiences and fans while performing at live public events such as shows, concerts, plays and sports events, at conventions, signing sessions, photo opportunities, movie premieres and the like, where audience members may directly view the celebrity and there is a chance, albeit a small one, for the specific audience member to get feedback from the celebrity so that the celebrity is aware of his existence, and possibly to exchange words or glances which is meaningful and worthwhile to the dedicated fan. Other common interactions with celebrities are by way of sending fan mail via regular post or e-mail, by participation or monitoring of online questions & answers sessions, in which a moderator filters questions posed by fans and the celebrity answers the selected questions publicly, typically in a text chat environment such as IRC, or via online news groups or forums.

Physical public events are limited in the sense that geographic barriers, travel costs, and other constraints make it difficult for individual fans to attend events where specific celebrities are present and may prohibit their attendance altogether. Many celebrities have crowded schedules and obligations on their time, and, even when attending public events, have little time for greeting the crowds.

It will be appreciated that the overall time put aside by the celebrity to attend a public engagement is substantially longer than the net time that the celebrity is in the public eye, and despite setting aside a morning or even a full day to attend an event, the time that the celebrity is available and accessible to the fan, for signing autographs, shaking hands and the like, is minimal.

Online question & answer sessions via Internet forums are unsatisfactory in that they typically lack the intensity of the experience of a one-on-one, personal interaction. Thus the traditional fan letters are currently the only means of contacting celebrities that is widely available to fans. Obviously however, most celebrities, especially the more popular ones, cannot afford to spend much of their valuable time reading and answering letters. Many fan letters never get read by the celebrity at all and fans are only too aware that even when personal replies are received they are typically drafted by a secretary and have rubber stamped signatures thereupon.

Public events may leave fans unfulfilled in their desire to brush against celebrities, since celebrities do not generally give individual fans their attention. Even during the most personal of interactions offered at public events, such as brief conversations at signing sessions and photo opportunities, the pressure of peering eyes and shoving from other fans awaiting their turn may lessen the private atmosphere of the meeting.

Personal interactions with celebrities are sometimes available to fans in the form of backstage passes or prearranged meetings. These meetings may be one-on-one or in groups. Such opportunities are often granted only to winners of sweepstakes, where the odds of winning may be very slim. Another form of personal interaction sometimes made available by certain celebrities is meal (usually dinner) engagements, dispensed by auction, whose proceedings are typically donated to charity. Such events are few and far between. This may be attributed to the fact that celebrities are poorly paid for such activities, and are therefore unmotivated to participate in them over more lucrative activities. Furthermore, the imposition on the celebrity is quite significant, and many celebrities look to minimize non-essential engagements of this nature to free themselves up to spend time with family.

Another aspect of celebrity-fan interaction is the possibility of obtaining souvenirs. Fans may keep concert tickets and programs of sporting events for many years after the event. The possibility of having one's photograph taken with a favorite celebrity, or to receive a personalized autograph goes a certain way towards satisfying the fan's need for some form of souvenir which can be both showcased and cherished as a memento. Since personalized souvenirs usually require face to face meetings and are therefore rare, fans often have to settle for off-the-shelf souvenirs such as autographs and/or other memorabilia that though signed by the celebrity, are typically not dedicated to a specific fan.

Some people may seek an audience with a celebrity not simply for a friendly chat but for the purpose of receiving professional advice from experienced, world renowned people. This may hold true in particular with regard to celebrities in the various practices of business, science and politics. This kind of audience usually requires privacy, and is therefore seldom attainable without considerable effort.

Media coverage of celebrities is intense. However, interviews with popular celebrities are few and far between, partially due to scarcity of time in such celebrities' schedules. When interviews are granted, it is usually to high profile media channels such as famous magazines or popular talk shows. As a method of communication for the purpose of interviews, it is well known to use the telephone, thereby cutting across geographical constraints and saving time and money on travel and personal meetings. One drawback of telephone interviews, however, is that such interviews cannot be filmed or photographed. A further drawback of all abovementioned forms of interview is the red tape and effort involved with booking an interview, particularly for low profile, un-“connected” journalists and there is seldom easy, direct access to celebrities or even to their agents or managers.

Another aspect of celebrity fandom is merchandising. Advertising celebrity-related products to fans is a well known practice, utilizing various media such as television and the internet. However, only a handful of methods exist for effectively targeting narrow audiences such as fans of a specific celebrity, sports team or television show. These methods include placing ads (advertisements) in specific websites, content targeted ads and carefully placed commercials. However, advertisers are always looking for new methods and media to increase the exposure of their offerings.

In addition to the advertising of celebrity-related products, another related field is celebrity-assisted advertising (not necessarily of celebrity-related products). Celebrities have been participating in advertising campaigns for many years, and advertisers find this to be very effective in setting trends towards their products and raising the exposure of these products. This affinity of advertisers towards celebrities has in recent years spawned another phenomenon—advertisers have been handing out various products to celebrities, free of charge, at almost every opportunity, in the hope of having the celebrities seen with the products or mentioning them in public, enabling the advertiser to then refer to the product “as used by such and such”. Even the very publicity of the give-away is sometimes enough to earn positive press coverage and prestige for the giver, therefore advertisers often compete amongst themselves in the value and magnitude of such gifts.

The Internet is being slowly expanded to provide services to celebrities and sometimes to their fans. Korean Patent Application Number KR2084843 titled “Method for supplying cultural commodity utilizing global star network infra” related to a method for supplying a cultural commodity utilizing a global star (i.e. celebrity) network infrastructure, provided to plan a communication among stars and a construction of a community by supplying a space for only stars, on-line or off-line, and to plan an activation of a star industry by providing a space for sharing information among stars and/or a star and fan. This application focuses on inter-star interaction and social networking and not on interaction with fans. The only reference to fans concerns an actual, physical/offline café and store, which will host celebrities periodically and sell some of their private items in a venue reminiscent of “Planet Hollywood”, “Hard Rock Café” and similar ventures.

Korean Patent Application Number KR3030809A titled “Online fan letter service system” relates to an online fan letter service system that is provided to notify a user whether a celebrity opens and reads his/her fan letters thereby enhancing the reliability of the fan letters. The system comprises a fan terminal, a celebrity terminal, a fan letter service server, a database, an SMS (Short Message Service) system, a CD production system, and the internet. The fan terminal and the celebrity terminal enable a fan and a celebrity to access the fan letter service server over the internet, respectively. The server transmits the fan letter from the fan terminal to the celebrity terminal, informs the fan terminal whether the celebrity opens and reads the fan letter, manages the database and sends instructions to the SMS system and the CD production system if necessary. The SMS system receives the instructions from the server, and sends the short message, made at the celebrity terminal, to the fan terminal over a wireless communication network. The CD production system records the fan letter on a CD according to the instruction from the server, and delivers the produced CD to the celebrity or the fan. This system provides the fan with an indication that the celebrity has accessed the fan mail, but it is still essentially a one-way interaction. The celebrity does not gain from the interaction and the fan does not get personalized response. Indeed, the cynical fan will realize that in all probability, the response is provided by an automatic answering system or at best, by a personal assistant, and not by the celebrity at all.

Japanese Patent Application Number JP2002328994 titled “System to Mediate Between Celebrities And Their Fans And Computer Program” relates to a communication agency system having a program server containing information about celebrities received from web servers to provide a mediating system where functions of a manager, a secretary and a production company can be carried out at low cost, and fans can attempt to make contact with an athlete, etc., in a carefree manner therefore promoting the communication between the athlete, etc., and his fans and providing business opportunities for the athlete.

In the system described, a celebrity and his fans are mediated though the Internet, by at least one website providing information concerning the celebrity, a program server for running a program to be shared on the websites is provided and a system managing computer is provided for accessing the program server.

Using the program server, a mediating system is provided to function as a communication tool between the celebrity and the fans and as a sales promotion tool for the celebrity.

This application does promote meetings with celebrities but such meetings are face to face and are limited by geographical constraints. In addition, this system does not provide these opportunities to the average fan, but rather only to fans that have some sort of a business proposition for the celebrity, such as hiring the celebrity to speak at a public event.

United States Patent Application Number US20050011945 titled “System and method for promoting fan loyalty using smart cards” relates to a system, method and computer program product for applying smart card technology and related integrated operations to the sports and entertainment industry for the purpose of promoting fan loyalty to sports and entertainment celebrities. Purchasing, virtual touring, and virtual interaction with a celebrity is achieved through the provision of user services, storage of data, and user-friendly methods for ordering and shipping merchandise from a host computer Web store that is connected to a celebrity's personal Website. The system, method and computer programs product rely on smart cards functioning with a smart card terminal to store data and to communicate on a plurality basis to transmit and receive data. The invention is also designed to facilitate navigation and enhance speed of access on PC and Mac™ platforms.

Whilst aiding commercialization of the celebrity and the purchasing of souvenirs, the method is unidirectional in that the celebrity is unaware of the fan.

Korean Patent Application Number KR5024476A titled “System and method for managing star membership members of each star using wireless data communication network” relates to a system and a method for managing star membership members of each star using a wireless data communication network provided to form a fan membership group of each star, discounting a call charge between group members by linking with a mobile communication computer, and forming a sympathizing zone between the star and fans by offering a real-time tracking service for the star. Fan computer terminals form a club or community online, and output and up/download data for performing fan club activities. Fan mobile terminal form the club or the community on the web, output and upload/download the data for performing the fan club activities, and perform voice call, message transfer, and large capacity data download. A star mobile terminal offers events and various benefit information for a star charge system by linking with a star membership management server (SMMS). The star membership management server stores/manages the data transmitted from the fan terminals, and offers a call charge discount service, and image/background/MP3 (MPEG level 3)/ring data of the star by linking with an intelligent network server (INS).

This invention facilitates fan club activities, which are unidirectional in the sense that although the fans may communicate freely with each other, the celebrity is unaware of the individual fans.

Korean Patent Application Number KR4066622A titled “Method for selling/using star gift certificate through internet” relates to a method for selling/using a star gift certificate through the Internet to use a portrait right of a star as an important value of a gift certificate and give a buyer of the star gift certificate the union between a favorite famous person and a fan. The star gift certificate is made by including a photo or an image of the star based on a portrait use contract with the star, a gift certificate number, a certification number, and a gift certificate password. The star gift certificate is sold/delivered to the buyer through a wire/wireless electronic settlement method. If the buyer registers to an online site provided from an issuance company as a member, the buyer receives a unique closed account. If the buyer inputs the gift certificate password printed on the gift certificate, an electronic cash account is received as much as an issued price of the gift certificate and the buyer uses the charged contents by using the electronic cash.

The method facilitates purchasing souvenirs of celebrities by fans. However, there is no interactive experience and the fan is only too aware that the celebrity is unaware of his existence.

United States Patent Application Number US20020010584A1 entitled “Interactive voice communication method and system for information and entertainment” enables a user to communicate with a representation of a personality and relates to an interactive voice communication method and system for communicating with personalities. Any sort of real or authored personality, including but not limited to celebrities, characters, and service personnel types, may be the object of the interaction provided by the invention. The system and method of the invention permits communication between a user and the personality, i.e., between a fan of a celebrity and the celebrity, or between a consumer and a virtual service-person, via telephone, audio, video, CD, DVD, Internet, stand-alone kiosks and wireless devices through use of voice response technology including speech recognition and natural language software.

Although appearing to facilitate communication between celebrity and fan, it will be appreciated that the communication is simply an illusion, in that voice response technology provides a simulation of the personality using prerecorded comments in answer to questions, whereas a real interaction with the celebrity is not supported.

Korean Patent Number KR1035202 titled “Internet service for delivering commodities only using address of sender” addresses the issue of celebrity privacy. An internet service for delivering commodities only using an address of a sender is provided to protect the private life of famous persons by delivering mail or a commodity to a famous person through a Web service based on the internet network. A user joins to the membership by connecting to an internet Web service server using a user computer and inputting personal information to a database. The user can prepare a fan letter using a letter editing program and can upload the letter to a notice board. If the user wishes to deliver a commodity to a famous person, the user connects to an information database service and searches and selects information with respect to the famous person and inputs one's address in a user address input program. The address data are transmitted from a temporary storing unit of the user address input program to a Web server of the delivery company. The delivery company takes a letter or a commodity of the user and delivers the letter or commodity to a storehouse of the service provider. The letter or commodity is sorted by receivers and delivered to a place in which the receiver frequently visits. If the letter or commodity was delivered successfully, a manager uploads confirmation of the fact that the receiver received the letter or commodity for display on the notice board.

Although facilitating sending electronic mail to the celebrity without compromising the celebrity's privacy, this patent application does not address the issue of receiving feedback from the celebrity and the interaction is one way only.

U.S. Pat. No. 6,800,031 titled “Method of conducting an interactive competition” describes an interactive competition conducting method involving receiving answers from a player and a celebrity and updating their scores correspondingly for each correct answer.

An interaction competition provides an entertaining enjoyable environment for a player to compete against a celebrity in a head-to-head trivia game. The questions may be associated with the celebrity rather than random general information or general trivia. The celebrity can participate via prerecorded audio media, prerecorded audio-visual media, or in a live real-time format. A goal of the competition is for a player to gain more points than the celebrity. Another goal of the competition is for the player to answer more questions correctly than the celebrity. At least one or more game episodes can be provided on computer-readable media. A game episode may be implemented with a product featuring a celebrity. The competition can be provided in many different gaming environments. The competition can be provided online via a web-based format; a television game show format; telephone call-in radio talk show format; or a cellular phone game format.

Although enabling the fan to interact with the celebrity, the interaction is carefully scripted and the celebrity is not generally aware of the fan.

Korean Patent Application Number KR3043528 titled “Method and System for Selling Goods, Signed by Famous Person, Over Internet” relates to a good-selling method and system provided to easily sell goods, signed by famous persons such as entertainers and professional sportsmen.

The method facilitates the user purchasing souvenirs concerning the celebrity but such souvenirs are not personalized or dedicated to the fan in any way.

Despite the prior art, there is a need for a system and method to strengthen and tighten the relationship between celebrities and their fans by providing more opportunities for them to interact, improving the atmosphere and quality of their interactions, and to severely curtail the time and cost overheads of such interactions for both sides. It would also be advantageous to create complete recordings of such meetings, thus providing a new and more intimate kind of souvenir to be cherished. Reporters may also benefit from embodiments of such a system and method if designed to more fairly provide opportunities to access the celebrity, and to combine the efficiency of telephone with the advantages of face to face meetings. The system may also advantageously provide a platform for advertisers to target both fans and celebrities in marketing celebrity-related merchandise to the former and offering free gifts to the latter. The present invention addresses these issues by presenting such a system and method.

### SUMMARY OF THE INVENTION

It is an aim of the invention to facilitate scheduling interactive sessions with celebrities.

It is a specific aim that such sessions are arranged commercially.

In accordance with a first aspect, the present invention is directed to providing a method for commercializing a celebrity's time, comprising the steps of:
a. defining a session for interaction with the celebrity;
b. offering the session for sale via an internet website;
c. accepting an offer from a buyer and
d. scheduling the session with the buyer such that said celebrity is obligated to interact with the buyer during the session.

In one embodiment, the session is a two way interactive session between the buyer and the celebrity, such as a telephone conversation or an interactive session via a website during which buyer can view a live video feed of the celebrity, for example.

The sale may be concluded by buyer offering a predetermined price.

Alternatively, the sale may be concluded by the successful buyer bidding a highest price within a predetermined time frame.

The predetermined time frame may be initiated by a first offer being made, or may commence at a preset time, such as when the session is first posted, for example.

The session may be available to all users of the invention, or may be restricted to members of a subgroup of these users.

In one embodiment, certain sessions are available to journalists only and such a session comprises an interview for subsequent publication in the mass media.

In another embodiment, certain sessions are professional consultations with celebrities.

Certain sessions may also comprise customized messages prerecorded by a celebrity and subsequently played back by buyer of said interaction.

Optionally, the session is conducted via a computer network.

Alternatively, the session is conducted by telephone.

Alternatively, the session is hosted by the website.

In one embodiment, the session is open to third parties to watch.

Optionally, the method includes the additional steps of recording the interaction and offering the recording to a party selected from the list comprising the buyer, the celebrity and third parties.

In a second aspect, the present invention is directed to a website offering sessions with a celebrity via the method of:
a. defining a session for interaction with celebrity;
b. offering the session for sale via a medium;
c. accepting an offer from a buyer and
d. scheduling the session with the buyer such that said celebrity is obligated to interact with the buyer during the session, substantially as described hereinabove.

Optionally, the website allows payment via credit card through a secured interface and/or supports payment via a redeemable internet currency.

Optionally, the website additionally offers merchandise associated with the celebrity.

Optionally, such merchandise is autographed by the celebrity.

Preferably, the merchandise is personally dedicated by the celebrity to the buyer.

In one embodiment, the website is dedicated to a specific celebrity.

In an alternative embodiment, the website comprises a dedicated portal offering access to a number of celebrities, each having a dedicated listing.

Optionally, the website comprises restricted fields displayed to celebrities only. Such fields may include advertisements offered to celebrities, which may be targeted to specific celebrities.

Optionally, the website is configured to display targeted advertisements of products and services to users, wherein the targeting is based on identities of celebrities viewed by the users.

The term “celebrity” is used somewhat loosely herein and includes all persons or characters whose company is sought after by members of the public that have not previously directly met therewith. Typically celebrities have dedicated audiences by virtue of having attained a certain degree of fame or reputation in one or more fields that include, inter alia, the entertainment business, the performing arts, sports, business, politics, science and the literary arts.

The term “creation” as used herein relates to a piece of work produced with the participation of one or more celebrities, and includes, inter alia, books, movies, television shows, music albums and video games.

The meaning of the term “group” as used herein includes any named amalgamation of two or more people, wherein one or more of which are celebrities, typically for the purpose of performing, creating or engaging in sporting activities. Examples of group types are musical bands, baseball teams and dance groups.

The meaning of “link” includes URL hyperlinks.

The meaning of “or” is inclusive, i.e. equivalent to the term “and/or”, unless otherwise stated or unambiguously not the case from context.

The meaning of “page” includes a document written in HTML (HyperText Markup Language), XHTML (Extensible HyperText Markup Language), WML (Wireless Markup Language) or an equivalent language, and containing visual or auditory information. A page is typically part of a website

The meaning of “the website” includes a website embodying the present invention.

The meaning of “user” includes a person who has registered to the website, typically a fan, an advice-seeker or a reporter.

The meaning of “website”includes a user-accessible virtual network site, typically on the WWW (World Wide Web) or an equivalent content distribution platform such as Freenet. A website consists of one or more pages and is served from one or more server computers over HTTP (HyperText Transfer Protocol) or an equivalent protocol. The term “website” does not refer to a geographic site, although it may be supported by one or several server/s at a single node of the network, located in a specific geophysical location.

### BRIEF DESCRIPTION OF THE DRAWINGS

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a flowchart of an exemplary method that may be used to effect the interaction between a celebrity and one or more users in a manner consistent with the principles of one embodiment of the present invention;

FIG. 2 is a flowchart of an exemplary method that may be used to effect targeted advertising in a manner consistent with the principles of one embodiment of the invention;

FIG. 3 is a schematic illustration of several pages and links between them in an exemplary website in accordance with one embodiment of the invention, demonstrating the process of browsing through a celebrity catalog;

FIG. 4 is a schematic illustration of several pages and links between them in an exemplary website in accordance with one embodiment of the invention, demonstrating the process by which a user may actualize an already scheduled session with a celebrity;

FIG. 5 is a high-level block diagram of an exemplary computer system that may be used to realize at least some of the various operations of a preferred embodiment of the invention, and

FIG. 6 is a flowchart of the essential steps of scheduling a session with a celebrity via the Internet in accordance with an embodiment of the invention.

### DESCRIPTION OF PREFERRED EMBODIMENTS

A system, a web-based service and a method are presented for enabling and facilitating direct interaction between celebrities and their audience. The system allows celebrities to offer services and goods for acquisition by fans. Such services and goods include personal online meetings with celebrities, prerecorded or live greetings from celebrities for birthdays or other special occasions, memorabilia, autographed merchandise and the like. One of the particular features of the web based service and system is that it allows scheduling of interactive meetings with the celebrity. Such meetings may vary somewhat between the various embodiments, and may include, inter alia, chats between the celebrity and a fan; a journalistic interview with the celebrity conducted by a reporter, such as a multimedia interview with a TV reporter; or a business consultation between a young entrepreneur and a world-class tycoon. It is a feature of the invention that such interactions may be both scheduled and conducted over the Internet, rather than face-to-face, thereby not posing geographic restrictions on the celebrity or the fan. According to another aspect of this invention, advertisers are offered a way to target specific celebrities and celebrity groups, as well as their respective audiences.

The present invention primarily relates to a system and method for bringing one or more celebrities and their audience closer together by enabling personal interaction between them. This is achieved by efficiently converting the time of the celebrities into a commodity that can be commercially marketed. Specifically, a segment of time allocated by a celebrity for sale via the invention may be broken into short intervals that are typically several minutes long, known hereinafter as sessions, each of which may then be put up for sale.

In one embodiment of the present invention, the buyer of such a session may, at a pre-designated time, converse with the celebrity via an online audio/video conferencing application. Advantageously, this audio/video conferencing application may be synchronized with the website server/s so that it may identify users and celebrities via logon credentials, verify that they are scheduled to meet, connect then to each other and disconnect them at the scheduled times, possibly without revealing their personal contact details to each other. This technique can protect the privacy of celebrities and users, and prevent subsequent attempts by users to contact celebrities outside the bounds of a purchased session, or attempts to give out or sell such contact information to third parties.

Another medium of interaction that may be used by a user and a celebrity for an interactive session is a telephone conversation, which may be a standard audio conversation or may be an audio-visual interactive experience by employing video-enabled telephones at both ends. Such a telephone-based session may be automatically initiated by means of an automatic switching system, configured to hide the caller IDs of the parties from each other. Other methods that may be employed to protect the privacy of celebrities and users include providing the celebrities with dedicated telephones that cannot receive incoming messages or calls, but may only be used to make outbound calls. Such outward calling phones may be used by celebrities to initiate calls to buyers without exposing themselves to the possibility of being contacted thereby.

A preferred embodiment of the present invention may use a publicly accessible website, in which a user may browse listings of available celebrities, typically sorted into categories. Alternatively, the website may enable the user to conduct a search for celebrities by certain criteria. Such a website may utilize a database for storage of its celebrity catalog, as well as storage of other pertinent data such as data related to features discussed hereinbelow, in a manner commonly employed in dynamic database-driven websites. This data may be entered into the database via appropriate forms within the website, or via a separate application.

In one embodiment of the present invention, a public profile page may be available to users for each celebrity listed in the website catalog. Such a web page may include personal information pertaining to the celebrity, such as name, gender, age and date of birth, as well as information regarding the celebrity's history such as biography, list of past creations and list of group affiliations. For example, an actor's profile page may include a list of roles played and films in which he/she has starred, a singer's page may include details of songs, hits and concerts, whereas a basketball player's page may include a list of the teams to which he has belonged over the years together with details of matches played and points scored in previous seasons. A multi-talented celebrity may be listed in more than one category. In such a case, the celebrity's page may include several listings of different sorts, for the different careers, such as books authored, sporting achievements and political career.

Similarly, each creation or group related to one or more celebrities listed in the catalog may have a page of its own within the website. Each such page may list all the celebrities that have been affiliated with that particular creation or group, as well as the details of their affiliation. For example, a page relating to a specific television show may list all celebrities (of those listed in the website's catalog) that participated in the making of the show, as well as details of episodes with which they were involved, their roles in the production (e.g. producer, director, actress), the names of the characters they portrayed (for actors and actresses) and the durations of their participation (e.g. seasons 1 through 3).

In another example, a page relating to a football team may list all celebrities listed in the website's catalog that have been involved with the team over the years, the nature of their association, be it manager, coach and/or player, the positions played, highlights, achievements and dates thereof.

The aforementioned types of pages—celebrity profile pages, creation pages and group pages—may advantageously be cross-linked by hypertext and other links, appropriately placed, thereby allowing a user viewing any specific page to easily move to related pages, by association. This may be useful for finding specific celebrities by their relationship to their peers.

For example, a user may choose to view a certain musician's profile page, then move from it (by clicking a link from the musicians band affiliation list) to the group page relating to a certain band to which that musician belongs or once belonged, and from there proceed (by clicking a link from the bands member list) to the profile page of another musician affiliated with the same band.

The details that appear in a celebrity's profile page may be entered into the website's database and updated thereafter via appropriate forms by either the celebrity, his/her representatives or by website administrators. For creations or groups, any of the celebrities affiliated with that creation or group, their representatives or administrators of the website may be given permission to enter and maintain data pertaining to that creation or group.

A preferred embodiment of the present invention may allow visitors of the website to register and log in as users, thus enabling the website to offer them customized and personalized services as discussed hereinbelow. These and other personal services may be accessible via links from one integrated page, possibly named “My Account” or similar. There may be several types or classes of users, such as fans, advice-seekers and reporters. User classes may overlap, such that a specific user may belong to more than one class. For certain user classes offering particular privileges, such as reporters for example, tangible proof of identity may be a precondition for inclusion therein, in addition to the standard user registration process. The class(es) in which a user is registered may affect the range of services and products offered to that user. For example, only a reporter may be allowed to purchase an interview session, whereas only an advice-seeker may be allowed to purchase a consultation session. The designation of a session may be defined when it is scheduled, as discussed below.

One personalized service that may be offered to users by the website is a “favorites” or “watch list” feature. Such a feature may enable users to mark certain celebrities or certain categories of celebrities for tracking, and to be subsequently notified whenever new sessions or products related to any of the marked celebrities become available for sale, or whenever new celebrities are added to the catalog in any of the marked categories. Such notifications, as well as other notifications sent by the invention, may be dispatched automatically by the website, for example via email, SMS or instant messaging.

Another personalized service that may be offered to users is a “request” or “wish list” feature, enabling users to post requests for specific celebrities or categories that are absent from the website, as well as to track the status of these requests.

A key service that may be offered only to registered users is the ability to buy the services and/or products offered on the website, as described below.

In addition to users, celebrities and their representatives or agents may be allowed to log in to the website, possibly with different privileges and permissions than those provided to regular users. These special permissions may be bestowed by an administrator of the website on a registered user, thus “promoting” him to the status of celebrity, or a celebrity account may be created by an administrator in the first place, such that the celebrity would not have to register. Once logged in, a celebrity may be allowed to revise his/her public profile, to view certain details regarding users with whom he/she is scheduled to meet, and to allocate time for new sequences of sessions, as detailed below.

A primary commodity that is made commercially available via the invention and that has not been previously marketed effectively is slots of celebrities' time that are dedicated to personal interaction with users. In one embodiment of the present invention, a celebrity may allocate a prescheduled amount of time—possibly several days, weeks or months in advance. This segment of time may then be automatically divided into shorter segments, or sessions, with intervals inserted in between them for breaks and to account for spillover of the sessions (which may occur for example in case of tardiness or technical difficulties). Typically a short spillover interval of one minute or so may be inserted following each session, whereas longer breaks may be inserted more sparsely, after every few sessions.

The length of sessions, their type/s and the length of breaks between them may all be determined by the celebrity him/herself or by his/her agent. Examples of session types may include live online meetings with users or greeting-recording sessions. The type of live sessions may be further divided into several types, including casual meetings with fans, consultation meetings with advice-seekers and interview meetings with reporters, for example. It is a particular feature of the invention that the sessions are typically offered, scheduled and hosted over the Internet, thus allowing a two way interaction with minimal geographical constraints.

Once allocated, sessions may be offered for sale on a celebrity's profile page, or on a separate page linked therefrom, using a hyperlink or similar technique. Some or all users may be notified of such new offerings. In one embodiment, those users who have specifically added the corresponding celebrity to their favorites list are notified, by e-mail or otherwise. In another embodiment, notification is provided to potentially interested parties such as users monitoring affiliated celebrities or tracking the category to which the celebrity is affiliated.

Users and potential users may be notified of current offerings by way of advertisements, which may be updated in real time to reflect the current offering and displayed in relevant pages of the website itself (such as relevant search result pages) or on other websites, such as gossip sites, entertainment magazines, fan-club websites and other celebrity-related websites.

If the sale of certain offered sessions is to take place by auction, as may be the case in a preferred embodiment of the invention, an entire allocated sequence of sessions may be sold within a single auction, wherein each session would be sold in a separate round of that auction. For example, an auction for a series of 20 five-minute live-meeting sessions that are scheduled to take place 3 months from now may be announced today, and may begin in 6 weeks. Once the auction begins, so does its first round. At that time, logged-in users may place their bids (providing their payment details in the process, or relying or previously provided and saved payment details). The round then ends within a predetermined amount of time. The second round follows and so forth, until all 20 rounds are over (one round is conducted per available session). Upon each sale, the buyer (the winning bidder), if any, is billed and notified of his/her win. The buyer may then proceed to a page containing a form for submitting details regarding the upcoming session, such as its context. For example, if the sold session is a real-time interactive web-based meeting, the buyer may write that the meeting has been bought as a surprise gift for his daughter, who is a big fan of this celebrity, for her 10^{th} birthday. In another example, if the sold session is an “offline” pre-recorded greeting, the buyer may be allowed to specify the exact greeting to be spoken, or a general outline thereof.

Within each round of an auction, the bidding may take place via proxy, as is well known in the field of online auctions. This system requires each user to enter a maximum acceptable bid instead of an explicit bid, and subsequently the website automatically submits bids on the users' behalves (up to their predefined respective maximums) as is required to outbid opponents. Each auction round may have a starting price (i.e. a minimum initial bid) and a reserve price (minimum price that a bid must surpass to win, even when it is the highest bid). Both of these properties may be shared by all rounds of the same auction. The maximum proxy bid, for any new bidder in a round barring the first one, may be required to surpass the current highest bid plus a certain “bid increment”. This bid increment may be calculated as a certain percentage of the current highest bid. The bid increment requirement serves to ensure that the highest bids progress in reasonable strides.

Once a session is sold, its details may be viewed by the corresponding celebrity and buyer, possibly accessed via their corresponding personalized “My Account” pages described above. Each of the parties may be allowed to view some details such as the time of the upcoming session and the sale price, as well as the context entered by the buyer as described above. Each of the parties may also be privy to certain details concerning the other, but often excluding private data such as contact details.

Sessions may be conducted via an audio/video conferencing application, which may be synchronized with the website server/s. Using such an application may enable a recording of each session to be made and stored on either or both of the parties' computers, or on a server. Recordings stored on a server may be offered for download to both parties, possibly via the “My Account” page. Old recordings may subsequently be removed from the server, after an appropriate amount of time, in order to conserve storage space.

In a preferred embodiment of the present invention, in addition to celebrity-user interaction sessions described above, other services and products may also be sold to users. These may be offered on a celebrity's page, a creation page, a group page or other pages. For example, merchandize such as memorabilia, collector's items, toys, DVDs, CDs, clothes and books may be sold. Such items may also be autographed, and such autographs may be personalized. For personalized autographs, users may be allowed to specify their desired inscription. In the case of non-autographed merchandise or merchandize with non-personalized autographs, these items may be sold for a fixed price, as is commonly the case with e-commerce websites. Conversely, in the case of personalized autographs, items may be sold by auction. A useful way to determine whether an item or service is sold by a fixed price or by auction is by applying the “scarcity” factor, i.e. comparing supply to demand. This factor, as well as others, may be applied on a case-by-case basis to decide the preferred mode of sale for each service and product offered on the website.

A preferred embodiment of the present invention may allow advertisers to target their advertisements, such that these advertisements will only be shown to specific celebrities, to specific groups of celebrities or to specific groups of users. For example, an advertiser may wish to offer certain celebrities some products as “freebies”, in hope that these celebrities may help promote these products simply by being seen with them. This advertiser may wish to show celebrities ads to that effect, and the invention may allow the advertiser to do so by providing an interface for advertisers to submit advertising content and to select specific celebrities or categories of celebrities to be shown that content. Each advertisement may be in one of several predefined formats. The submission interface may be a part of the website or a separate website, and may contain one or more pages with one or more web forms, as appropriate. Submissions may also be accepted by email or by other means. Acceptable advertisement formats may include textual ads, graphic banners (animated or static) or video commercials. The latter may be displayed via the audio/video conferencing application, possibly in between sessions. Advertisements may also be concentrated in one or more pages of their own, accessible from the website's navigation menu and titled “offerings”, “freebies” or similarly. Celebrities may choose not to view advertisements, either by the “opt-out” or the “opt-in” approach, i.e. the default behavior of the website may be either to display advertisements to all celebrities who have not explicitly asked not to see them, or not to show any advertisements to any celebrity unless he/she explicitly asked to see them, respectively. This preference may be set by the celebrity at the time of registration to the website and changed at any later time.

In another example concerning advertisements, advertisers may wish to offer celebrity-related services or products for sale to non-celebrity users of the website. The submission of content and the targeting of users may be done in a manner similar to that described above for celebrities, with the important difference that users may not be targeted specifically (e.g. by name), but rather by categorizing the user according to his/her behavior patterns, e.g. according to celebrities, categories, groups or creations whose pages the user visits. Users may or may not be allowed to control their exposure to advertisements, and if allowed—either the “opt-out” or “opt-in” approach may be used, as explained above.

The figures shall now be described and discussed in detail.

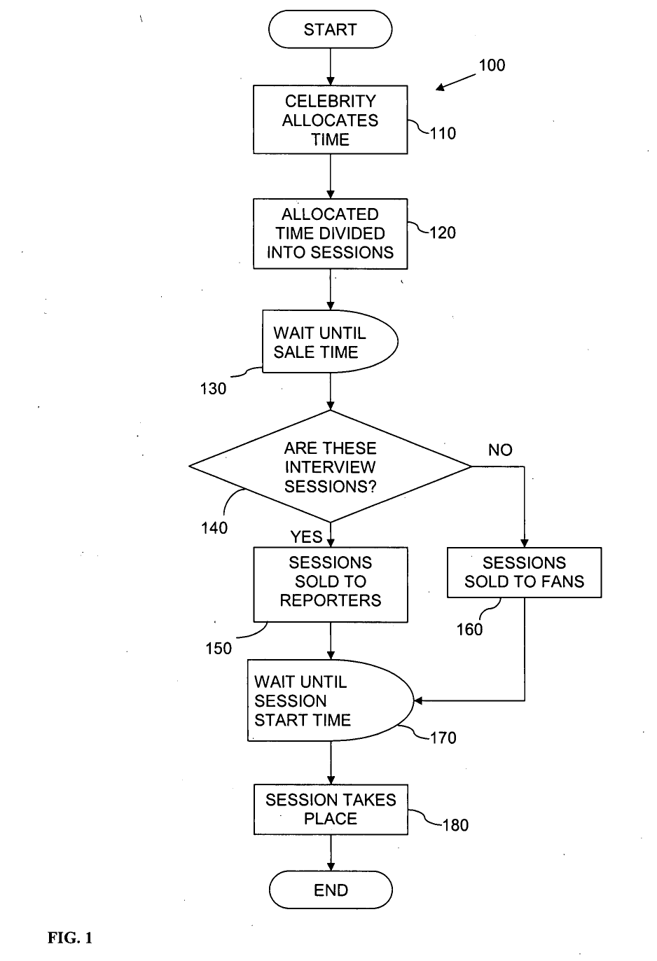

FIG. 1 is a flowchart illustrating an exemplary method 100 that may be used to effect the interaction between a celebrity and one or more users in a manner consistent with the principles of the invention. The method 100 is invoked every time a celebrity (or a representative thereof) decides to offer some of the celebrity's time for sale. First, the celebrity (or representative thereof) allocates a block of time 110 for meetings, at which time other pertinent data may be specified, such as the length of each session the price of each session if the sale is by a fixed price per session, or, where auctioned, the starting or reserve price for each session, the length and frequency of breaks between meetings and similar details.

Based on the entered data, the invention generates a session schedule wherewith the time allocated is divided into sessions 120, as well as a sale schedule, which may be set to begin a fixed amount of time before the first session begins, and may also depend on the number of sessions. For example, an auction for 20 sessions may begin 20 hours before the first session, wherein every session is auctioned off during the course of one hour (i.e. one auction round per hour). The depicted process is then put on hold until the designated sale time 130. Upon the beginning of the sale, authorized users are allowed to participate in accordance with their user type. Thus, if the session designation is reporter-oriented, e.g. an interview 140, only reporters may be allowed to purchase or bid for the sessions 150. Otherwise, only fans may be allowed to purchase or bid for the sessions 160. It will be appreciated that this example is simplified to best explain the idea, and relates to the classes of reporters and fans only. In other embodiments, there may be other user types or classes and sessions may be offered to a combination of several such classes, such as long term fans, or users in a particular age group, sex or income bracket, for example. Users will be decided as qualifying for particular classes accordingly to their individual profiles. Certain sessions may be sold by fixed price, in which case the sale may be on a first-come-first-served basis, or randomly, by a raffle for example. Alternately, users may compete for the sessions by auction, possibly placing their bids by proxy, submitting their payment details either before placing their bids or immediately after winning. The depicted process is then generally placed on hold until the designated start time of the session sequence 170. When the scheduled time of the session batch arrives, the sessions take place in turn, as scheduled 180. If the sessions are real-time, online sessions, as may be the case in a preferred embodiment of the present invention, the celebrity and users may each log into an audio/video conferencing application, either embedded within the website, accessible therefrom, or separately configured, in order to actualize the session and communicate with each other. In another embodiment of the present invention, the session may take place over a telephone line.

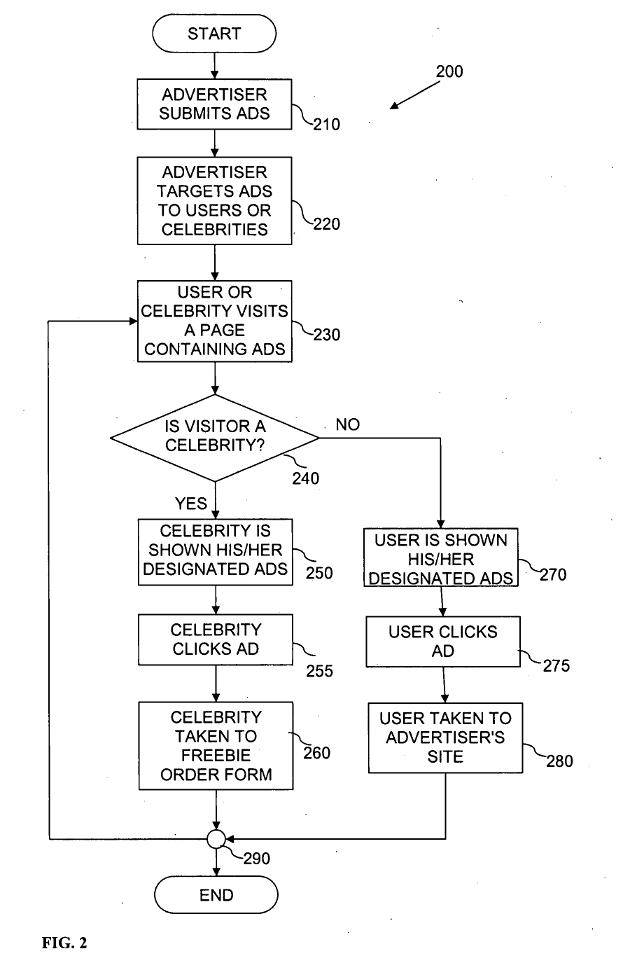

FIG. 2 is a flowchart illustrating an exemplary method 200 that may be used to effect targeted advertising in a manner consistent with the principles of the invention. The method 200 may be invoked every time an advertiser submits targeted advertisements to the website. The first step 210 of the method 200 is typically that the advertiser submits one or more advertisements to the website; via a specialized upload form within the website, via email or via another method for example, specifying the types of advertisements being submitted (textual, video, banner or other), the page(s) in which each of the advertisement is to appear and other pertinent details. The advertiser may then specify the target audience for the advertisement, which may be, inter alia, one or more specific celebrities, a certain group of celebrities defined by category or other common criteria, all celebrities, users who view pages of certain celebrities, specific types of users such as fans, advice-seekers, reporters, or combinations of these criteria 220.

Whenever a visitor visits 230 any page on the site that contains one or more advertisements, the visitor account type is checked to see if the visitor is a celebrity 240. If the visitor is indeed a celebrity, he/she may be searched for in the target list of each celebrity-targeted advertisement in the page, and if the celebrity appears in the list, he/she will be shown the corresponding advertisement/s 250. Such advertisements may relate to freebies or giveaways, i.e. free products or services. Once one such advertisement is selected 255, the celebrity may be offered an order form 260, where he/she may confirm his/her interest in receiving the advertised free item. If the visitor is a user, or a guest i.e. a visitor who has not logged in, he/she may be searched for in the target list of each user-targeted advertisement in the page, and if found—shown the corresponding advertisement 270. Such advertisements will typically offer products or services for sale (as opposed to the advertisements shown to celebrities). Once one of these advertisements is selected 275, the user may be taken to an appropriate page in the advertiser's website 280. This sub-process of selecting advertisements to be shown to a visitor according to targeting parameters 240, showing them 250/270, letting the visitor select advertisements by clicking thereon 255/275 and taking the visitor to the appropriate page 260/280, may be repeated indefinitely 290, such as every time a visitor views a page within the website 230, for example.

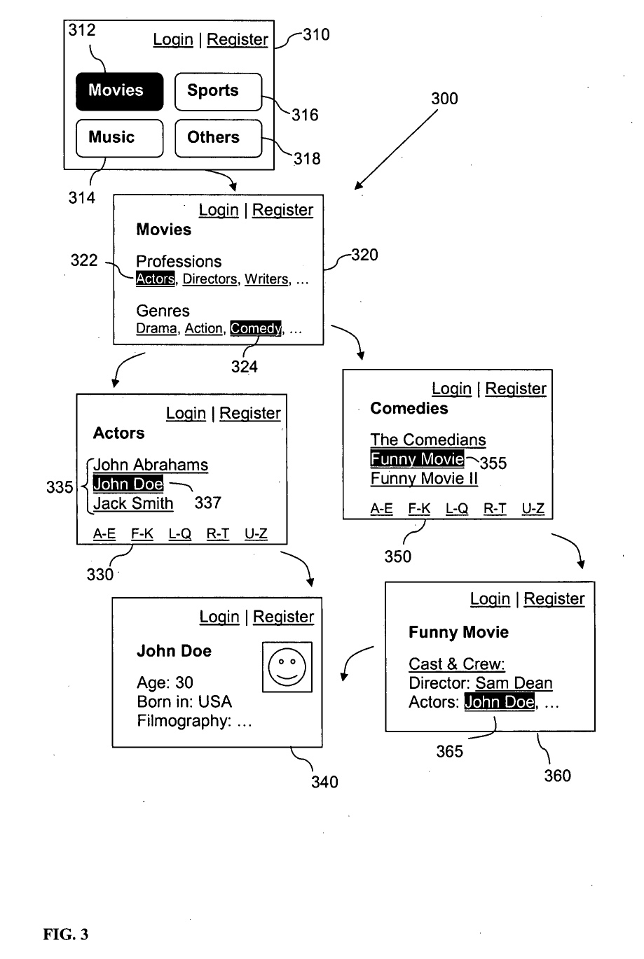

FIG. 3 is a schematic illustration of several pages and links between them in an exemplary website 300 that embodies the invention, demonstrating the process of browsing through a celebrity catalog. This website 300 includes several pages 310, 320, 330 . . . and links between them, comprising a celebrity catalog. By way of example, a visitor to the website may first visit the website's home page 310, which may contain links to the main categories of the celebrity catalog, such as Movies 312, Music 314, Sports 316 and Others 318. For example, the visitor may then select the “Movies” link 312 and thereby access the “Movies” category page 320. The “Movies” category page 320 may contain a category hierarchy wherein each item is a link to a category page or any other pertinent page. For example, an “Actors” link 322 may lead to an “Actors” page 330, which may contain a listing 335 of all movie actors listed in the catalog. Clicking on one of the actor links, for example “John Doe” 337, leads to the corresponding celebrity's public profile page 340. Another example of browsing the catalog would be to proceed from the “Movies” category page 320, via the “Comedy” link 324, to the “Comedies” page 350, which may list all comedies pertaining to all the celebrities listed in the catalog. Clicking on a link corresponding to one of these comedies, “Funny Movie” 355, may lead to the corresponding “Funny Movie” creation page 360, which in turn may contain links to public profiles pages of participating celebrities, such as a link to John Doe 365 which will, again, lead to the “John Doe” page 340.

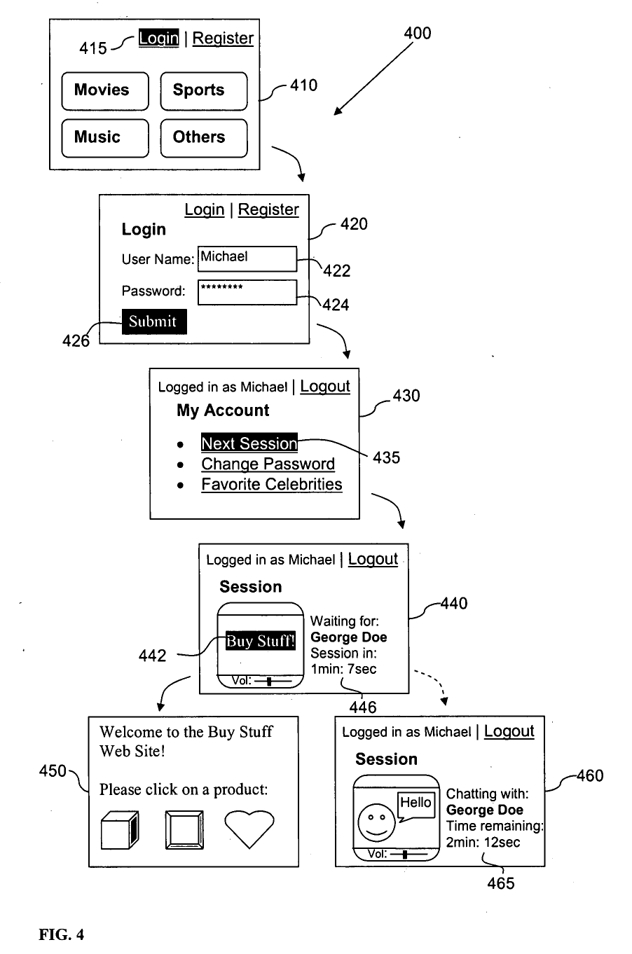

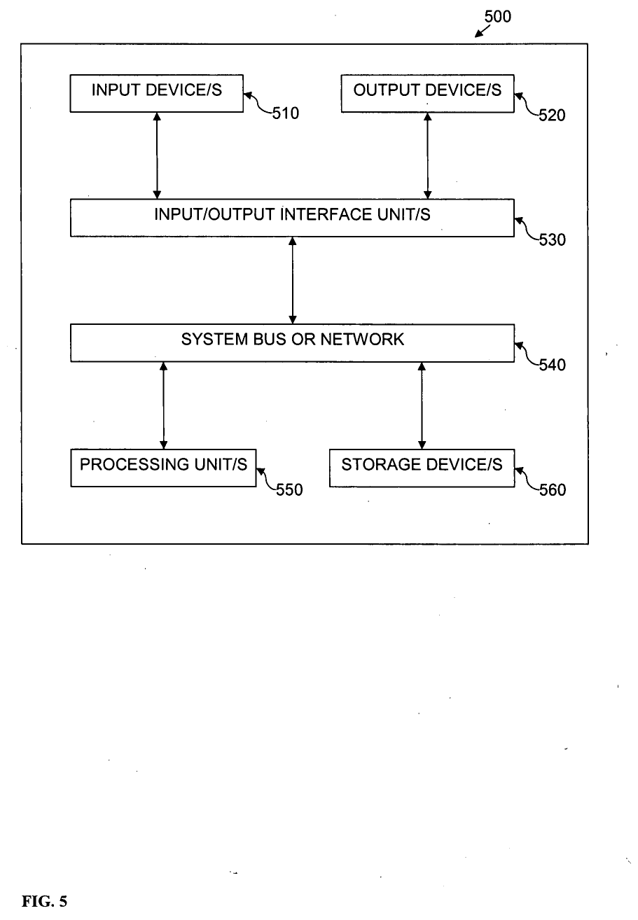

FIG. 4 is a schematic illustration of several pages and links between them in an exemplary website 400 that embodies the invention, demonstrating the process by which a user actualizes an already scheduled session with a celebrity. A visitor to the website 400 may first visit the website's home page 410, containing a link 415 to a login page 420. Upon entering his/her login name and password into the appropriate fields (422, 424 respectively) and submitting the form 426, the user's personal Account page 430 is opened. If the user has an upcoming session with a celebrity, a “Next session” link 435 may be available, leading to the session page 440, in its pre-session state (assuming that the user is not late, i.e. that the session start time has not yet arrived). The session page 440 may contain an embedded client of a video-conferencing application 442, which may be configured to play back video commercials until the session begins. A timer 446, counting down towards the scheduled session start time, may also be displayed. Clicking on the client framed 442 while a commercial is playing may lead to the advertiser's website, which may be opened in a new “pop up” window 450 rather than in the current browser window (so as to leave the session page open). Once the session's start time arrives, the video conference between the user and the celebrity may begin 460, i.e. the client frame may begin to show a live video feed being broadcast from the celebrity's webcam, and a corresponding audio feed from the celebrity's microphone may simultaneously be played to the user via the sound card of the users' terminal equipment. The timer 465 may then be used to display the remaining time until the end of the session. A process similar to the one described for the user in FIG. 5 may apply to the celebrity as well, mutatis mutandis, with the user's and celebrity's roles reversed accordingly.

FIG. 5 is a high-level block diagram of an exemplary computer system 500 that may be used for performing at least some of the various operations of a preferred embodiment of the invention. Such a computer system 500 may be distributed over several nodes of the Internet, and supported by one or more computers serving as web server(s) at a web-hosting facility and other computer(s) being a personal computer used by visitors to the website be they fans, celebrities or advertisers, for example. Each computer terminal in the system may include one or more input device(s) 510, such as a mouse, keyboard, microphone or webcam, for example. Each such system may further include one or more output device(s) 520, such as a monitor, speakers, headset or printer, for example. Such input and output devices 510, 520 may be coupled with one or more input/output interface unit(s) 530, which may, in turn, be connected to a system bus or network 540, which may serve as the primary communication channel between major components of the computer system. The system bus or network 540 may be used to convey machine-executable instructions that effect one or more aspects of the present invention from one or more input device(s) 510 via the input/output interface 530 or storage device(s) 560 e.g. random-access memory, read-only memory, hard disk drive, flash disk drive or optical drive, to one or more processing units 550 (e.g. microprocessors). The processing unit(s) 550 may in turn carry out these instructions and convey results, via the system bus or network 540, to one or more output device(s) 520 (via the input/output interface 530 or storage device(s) 560.

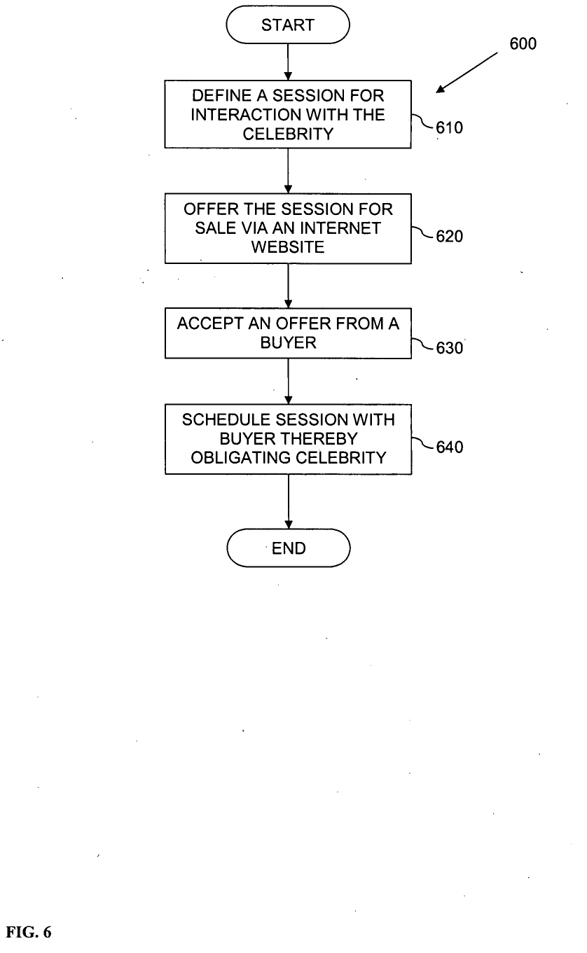

FIG. 6 is a flowchart of the essential steps 600 of scheduling a session with a celebrity via the Internet in accordance with an embodiment of the invention. The process consists essentially of the following stages: Defining a session for interaction with the celebrity 610; Offering the session for sale via an internet website 620; Accepting an offer from a buyer 630 and Scheduling the session with the buyer such that said celebrity is obligated to interact with the user during the session 640.

As can be appreciated from the description hereinabove, the invention may be used to substantially expand opportunities for interaction between celebrities and their audience, as well as to expand opportunities for advertisers to target celebrities and their fans.

Although the present invention has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A method for commercializing a celebrity's time, comprising:
the steps of:
a. defining a session for interaction with the celebrity by a designated user;
b. offering the session for sale via an internet website;
c. accepting an offer from a buyer and
d. scheduling the session with the buyer such that said celebrity is obligated to interact with the user during the session.

2. The method of claim 1, wherein the session is a two way interactive session with the celebrity.

3. The method of claim 1, wherein the session is a telephone conversation.

4. The method of claim 1 wherein the session is an interactive session via a website during which the buyer and the celebrity can partake in one or more forms of intercommunication selected from the list comprising:
(i) text messaging;
(ii) audio communication, and
(iii) video communication

5. The method of claim 1 wherein said sale is concluded by one of the following predetermined events:
(i) offering a predetermined price;
(ii) bidding a highest price within a predetermined time frame initiated by a first offer being made, and
(iii) bidding a highest price within a predetermined time frame initiated by the session being posted.

6. The method of claim 1, wherein the session is available to journalists only and comprises an interview for subsequent publication.

7. The method of claim 1, wherein said session is a professional consultation with the celebrity.

8. The method of claim 1 wherein said celebrity can exercise a veto, returning the purchase price.

9. The method of claim 1, wherein said session is conducted via a computer network.

10. The method of claim 1, further comprising recording said interaction and offering said recording to a party selected from the list comprising the buyer, the celebrity and a third party.

11. A website offering sessions with a celebrity via the method of claim 1.

12. The website of claim 11 allowing payment via credit card through a secured interface.

13. The website of claim 11 facilitating payment via a redeemable internet currency.

14. The website of claim 11 further offering merchandise associated with the celebrity.

15. The website of claim 14, wherein said merchandise is autographed by the celebrity.

16. The website of claim 15, wherein said autographed merchandise is personally dedicated to the buyer.

17. The website of claim 11 being selected from the list of a website dedicated to a specific celebrity and a portal serving a number of celebrities, each having a dedicated listing.

18. The website of claim 11 comprising restricted fields displayed to celebrities only.

19. The website of claim 18 wherein said fields include advertisements offered to the celebrity.

20. The website of claim 19 wherein said advertisements are targeted to a specific celebrity.

21. The website of claim 11 configured to display targeted advertisements of products and services to users, wherein the targeting is based on identities of celebrities viewed by said users.
